(19) United States
(12) Patent Application Publication
(10) Pub. No.: US 2015/0112941 A1
(43) Pub. Date: Apr. 23, 2015

(54) BACKUP MANAGEMENT SYSTEM AND METHOD THEREOF

(71) Applicant: POWER-ALL NETWORKS LIMITED, Shatin (HK)

(72) Inventors: ZHI-HUI CAI, Hong Kong (CN); JUN LV, Hong Kong (CN); MENG-MING HUANG, Hong Kong (CN); JIAN-PING ZHANG, Hong Kong (CN)

(21) Appl. No.: 14/514,875

(22) Filed: Oct. 15, 2014

(30) Foreign Application Priority Data
Oct. 18, 2013 (CN) 201310493949.5

(51) Int. Cl. G06F 17/30; G06F 11/14

(52) U.S. Cl. CPC G06F 17/30088; G06F 11/1448; G06F 11/1464
USPC 707/649; 707/654

(57) ABSTRACT

A backup management system includes a backup manager and a number of agents. Each of the agents is in communication with the backup manager and with each other through a network. Each of the agents includes at least one virtual machine (VM). Any agent of the number of agents can send a backup request to the backup manager when the agent needs to back up the at least one VM. The backup manager can instruct the agent how to back up the at least one VM to another agent of the number of agents.

### FIELD

The present disclosure relates to backup management systems and methods, and particularly to a backup management system and method for backing up a virtual machine (VM) of an electronic device.

### BACKGROUND

Data of an electronic device can be backed up. The backed up data can be used to restore data of the electronic device.

### BRIEF DESCRIPTION OF THE DRAWINGS

Implementations of the present technology will now be described, by way of example only, with reference to the attached figures.

FIG. 1 is a diagram of a first exemplary embodiment of a backup management system.

FIG. 2 is a block diagram of an exemplary embodiment of a backup manager of the backup management system.

FIG. 3 is a block diagram of an exemplary embodiment of a backup assistance system of the backup manager.

FIG. 4 is a block diagram of an exemplary embodiment of an agent of the backup management system.

FIGS. 5-6 are a block diagram of an exemplary embodiment of a backup implementation system of the agent.

FIG. 7 is a diagram of an exemplary embodiment of a backup management method.

FIG. 8 is a diagram of copying a logical volume of a first virtual machine of a first agent to a second agent.

FIG. 9 is a diagram of a second exemplary embodiment of a backup management system.

FIGS. 10-13 are a flowchart of an exemplary embodiment of a backup management method.

FIG. 14 is a flowchart of an exemplary embodiment of a backup recovery method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Definitions that apply throughout this disclosure will now be presented.

The references “a plurality of” and “a number of” mean “at least two.”

The term “comprising,” when utilized, means “including, but not necessarily limited to”; it specifically indicates open-ended inclusion or membership in the so-described combination, group, series, and the like.

In general, the word “module” as used hereinafter refers to logic embodied in hardware or firmware, or to a collection of software instructions, written in a programming language such as, for example, but not limited to, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

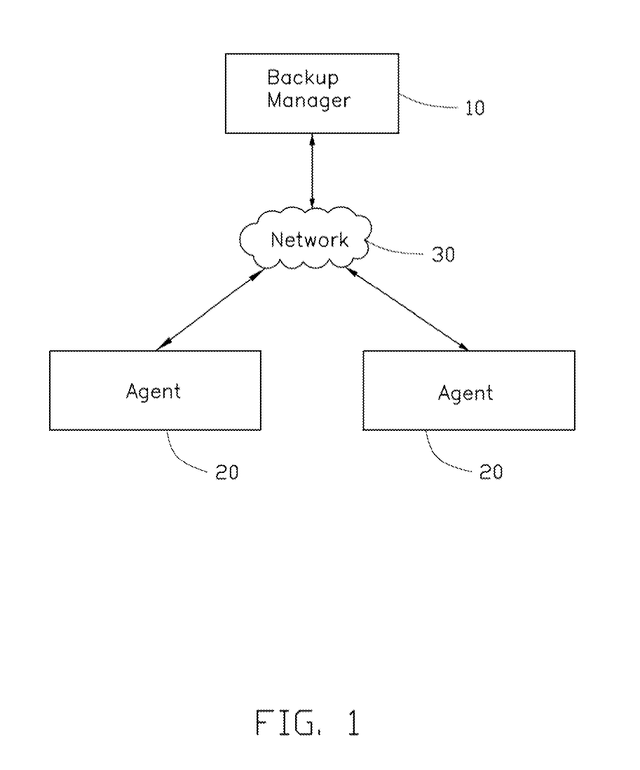

FIG. 1 illustrates a first example embodiment of a backup management system. In at least one embodiment, the backup management system can include a backup manager 10 and a plurality of agents 20 (only two shown). Each agent 20 can communicate with the backup manager 10 through a network 30, and each agent 20 can communicate with each other through the network 30. In at least one embodiment, each agent 20 can be an electronic device such as a personal computer, a tablet computer, or any other suitable electronic device. The network 30 can be the Internet, a communication network, or a local area network based on BLUETOOTH, ZIGBEE, or WIFI, for example.

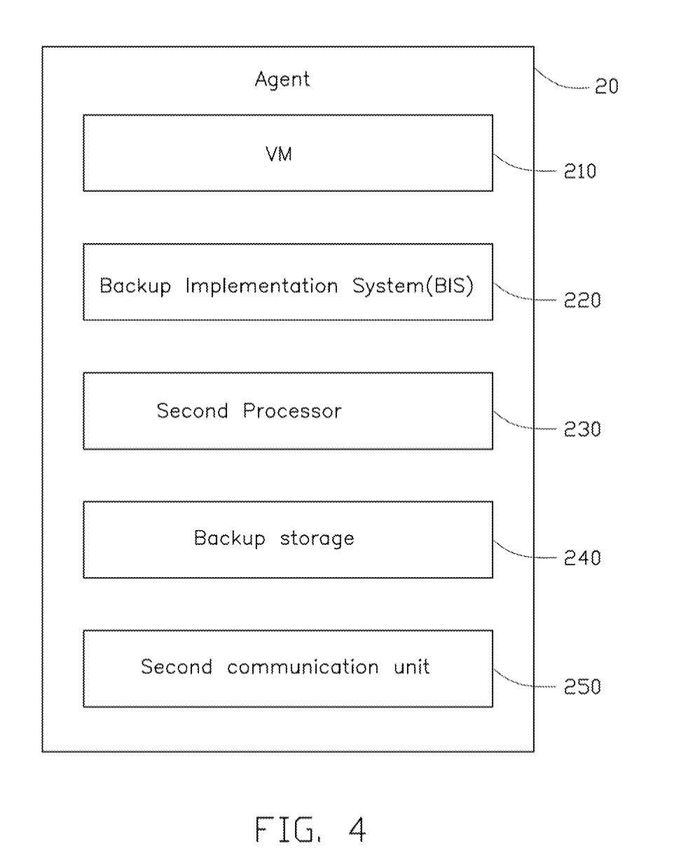

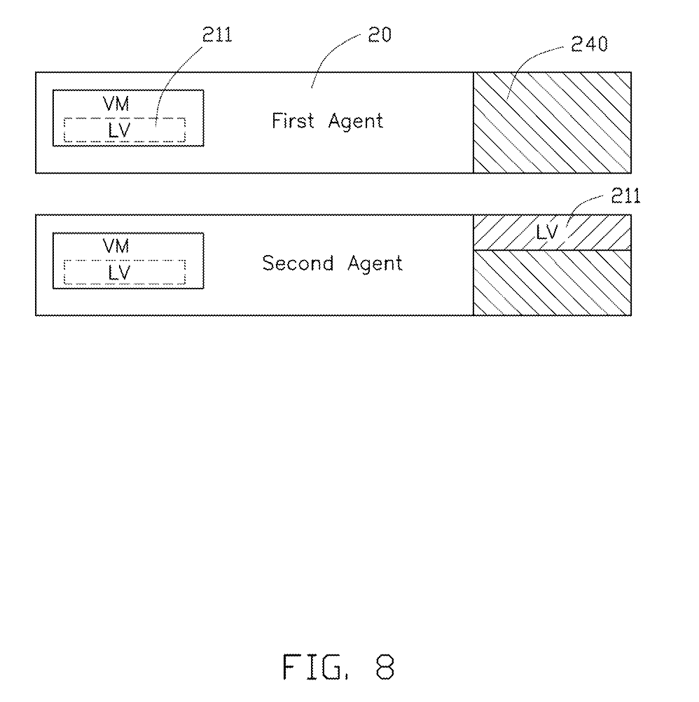

Each agent 20 can include a virtual machine (VM) 210 (shown in FIG. 4). Each VM 210 can include a plurality of logical volumes (LV) 211 (shown in FIG. 8, only one LV shown). In the backup management system, any agent 20 can back up the corresponding VM 210 to another agent 20. For simplicity and clarity of illustration, a process of backing up the VM 210 of a first agent 20 (shown in FIG. 8) to a second agent 20 (shown in FIG. 8) will be described. In at least one embodiment, the VM 210 of the first agent 20 can be backed up to the second agent 20 by copying the LV 211 of the VM 210 of the first agent 20 to the second agent 20.

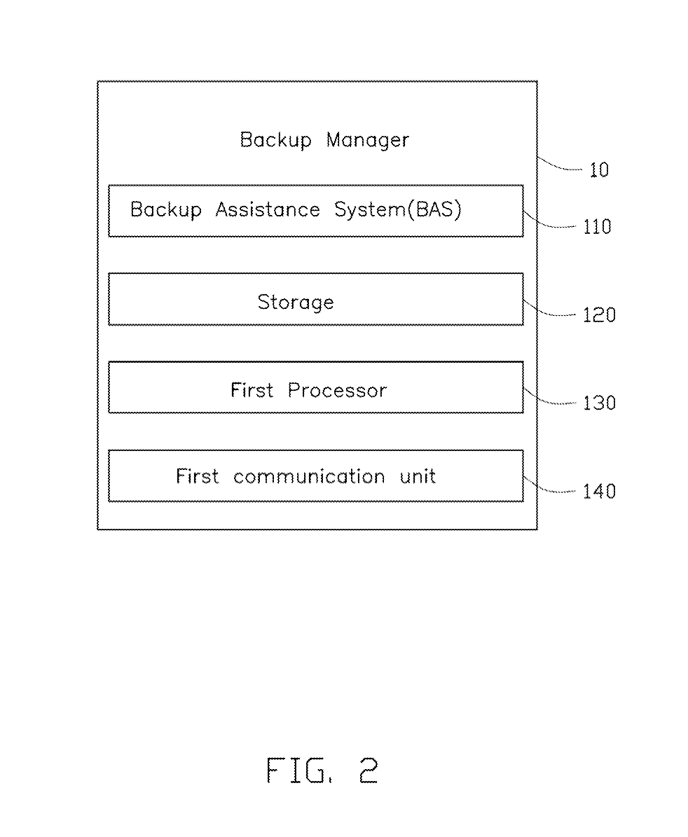

FIG. 2 illustrates an example embodiment of the backup manager 10. In at least one embodiment, the backup manager 10 can include a backup assistance system (BAS) 110, a storage 120, a first processor 130, and a first communication unit 140. The first communication unit 140 can be used to connect to the network 30. The BAS 110 can assist the first agent 20 in backing up the VM 210 to the second agent 20.

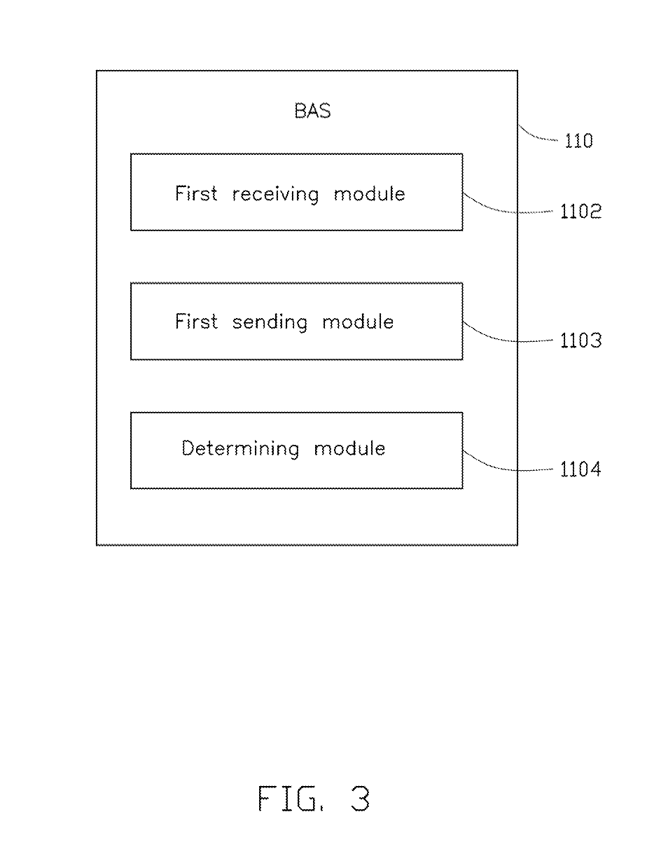

FIG. 3 illustrates an example embodiment of the BAS 110 of the backup manager 10. In at least one embodiment, the BAS 110 can include a plurality of modules, such as a first receiving module 1102, a first sending module 1103, and a determining module 1104. The plurality of modules of the BAS 110 can comprise one or more software programs in the form of computerized codes stored in the storage 120. The computerized codes can include instructions executed by the first processor 130 to provide functions for the plurality of modules of the BAS 110.

The first receiving module 1102 can obtain information including a current amount of free space of each agent 20 at predetermined regular time intervals, and further receive a backup request from the first agent 20. The determining module 1104 can determine whether the first VM 210 of the first agent 20 has been backed up before. If the determining module 1104 determines that the VM 210 of the first agent 20 has not been backed up before, the determining module 1104 determines which agent 20 of the other agents 20 has a largest current amount of free space. The determining module 1104 designates the agent 20 having the largest current amount of free space as the second agent 20. After the determining module 1104 designates the second agent 20, the first sending module 1103 sends a first message to the first agent 20 instructing the first agent 20 to back up the VM 210 to the second agent 20. For example, the first message can include the designated second agent 20 and the current amount of free space of the second agent 20. If the VM 210 has been backed up before, the determining module 1104 determines which agent 20 of the other agents 20 the first VM 210 was backed up to before, and the first sending module 1103 sends a second message to the first agent 20 informing the first agent 20 that the VM 210 was backed up to the second agent 20 before.

FIG. 4 illustrates an example embodiment of each agent 20. In at least one embodiment, each agent 20 can further include a backup implementation system (BIS) 220, a second processor 230, a backup storage 240, and a second communication unit 250. The second communication unit 250 can be used to connect to the network 30. The BIS 220 can be used to back up the VM 210 of the first agent 20 to the backup storage 240 of the second agent 20.

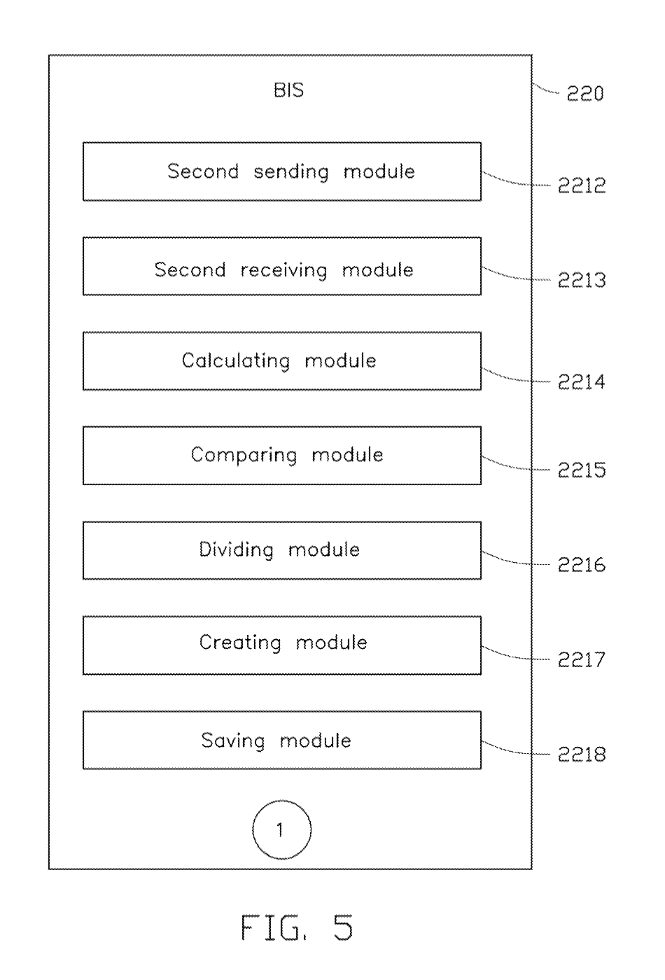

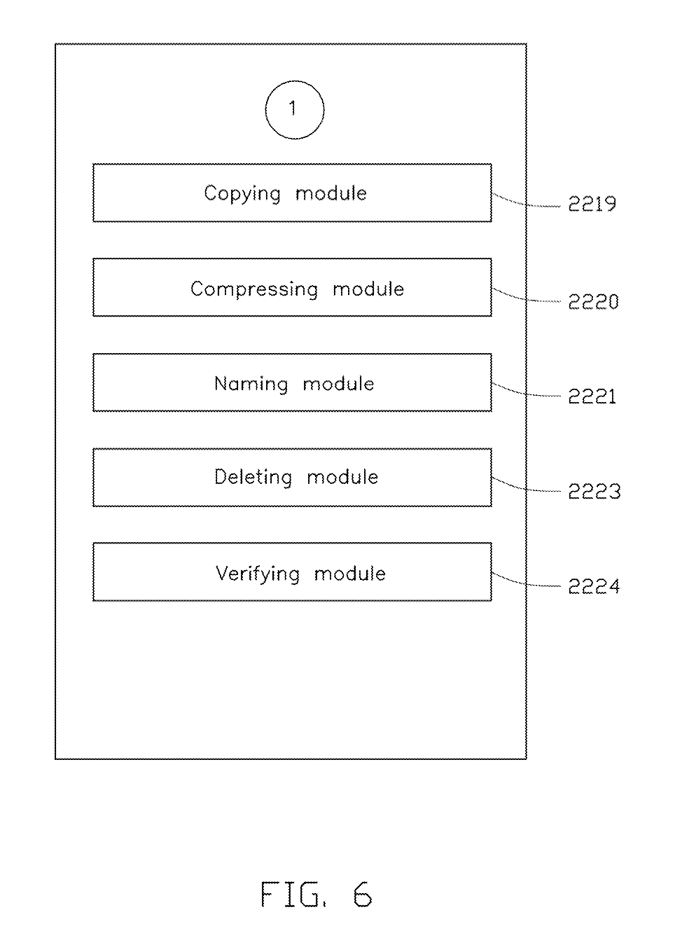

Referring to FIGS. 5-6, the BIS 220 can include a plurality of modules, such as a second sending module 2212, a second receiving module 2213, a calculating module 2214, a comparing module 2215, a dividing module 2216, a creating module 2217, a saving module 2218, and a copying module 2219. The plurality of modules of the BIS 220 can comprise one or more software programs in the form of computerized codes stored in the backup storage 240. The computerized codes can include instructions executed by the second processor 230 to provide functions for the plurality of modules of the BIS 220.

In at least one embodiment, the second sending module 2212 can send information including the current amount of free space to the first receiving module 1102 of the BAS 110, and further send the backup request to the first receiving module 1102 of the BAS 110. The second receiving module 2213 can receive the first message and the second message from the first sending module 1103 of the BAS 110.

The calculating module 2214 can calculate a required amount of backup space of the backup storage 240 of the second agent 20 to back up the VM 210 of the first agent 20. In detail, the calculating module 2214 first obtains a size of each LV 211 of the VM 210, and adds the sizes of all of the LVs 211 together to obtain a total size. The calculating module 2214 multiplies the total size by a compression ratio to obtain the required amount of backup space. For example, if the calculating module calculates the total size “total_size” and the compression ratio is 70%, the required amount of backup space “backup_space” is calculated by the following formula: backup_space=total_size*70%.

The comparing module 2215 can compare whether the required amount of backup space is less than or equal to the current amount of backup space of the backup storage 240 of the second agent 20. When the required amount of backup space is less than or equal to the current amount of backup space, the VM 210 of the first agent 20 can continue to be backed up to the second agent 20. Otherwise, when the required amount of backup space is greater than the current amount of free space, the second sending module 2212 can send a message to a display (not shown) of the first agent 20 to inform a user.

The dividing module 2216 can divide each LV 211 into a plurality of files according to a predetermined rule. The creating module 2217 can create a temporary file from each file. For example, the temporary files can be of the form “*.img.gz” wherein * represents a serial order of creating the corresponding temporary file. The calculating module 2214 can further calculate an md5 value of each temporary file. The saving module 2218 can save each md5 value to the storage 120 of the backup manager 10. The copying module 2219 can copy each temporary file to the backup storage 240 of the second agent 20.

Referring to FIG. 6, the BIS 220 can further include a compressing module 2220, a naming module 2221, a deleting module 2223, and a verifying module 2224.

The naming module 2221 can assign an LV name to each LV 221 of the VM 210 before the dividing module 2216 divides each LV 221 into the plurality of files. The creating module 2217 can create a snapshot of each LV name. In at least one embodiment, the snapshot is used to record an operation status of the corresponding LV 221 at a time when the LV name was created. The compressing unit 2220 can compress the temporary files before being copied to the backup storage 240 of the second agent 20. The deleting unit 2223 can delete the temporary files and the LV names from the first agent 20 after the temporary files are copied to the second agent 20.

When the VM 210 of the first agent 20 has been backed up to the second agent 20 before, the calculating module 2214 can divide the plurality of files of the LVs 221 according to the predetermined rule. For example, the temporary files can be of the form “*.img” wherein * represents a serial order of creating the corresponding temporary file. After the calculating module 2214 calculates the md5 values of the temporary files, the comparing module 2215 can compare the md5 values of the temporary files to corresponding md5 values stored in the storage 120 of the backup manager 10. When the md5 values of the temporary files are the same as the corresponding md5 values stored in the storage 120 of the backup manager 10, the deleting module 2223 can delete the corresponding temporary files from the first agent 20. When the md5 values of the temporary files are different from the corresponding md5 values stored in the storage 120 of the backup manager 10, the saving module 2218 can save the corresponding md5 values to the storage 120 of the backup manager 10 to replace the corresponding md5 values that were saved a previous time, and the copying module 2219 can copy the corresponding temporary files to the backup storage 240 of the second agent 20 to replace the corresponding temporary files that were copied to the second agent 20 the previous time. For example, the compressing module 2220 can compress the temporary files “*.img” as “*.img.gz” to replace the corresponding temporary files in the backup storage 240 of the second agent 20. Thus, only data in the temporary files that has been changed is copied to the second agent 20, thereby decreasing a required amount of time and bandwidth to back up the VM 210 a second or more time.

When the first agent 20 needs to recover the backup of the VM 210, the second sending module 2212 of the first agent 20 can send a backup recovery request to the first receiving module 1102 of the backup manager 10. After the first receiving module 1102 receives the backup recovery request, the determining module 1104 can determine which agent 20 the VM 210 was backed up to before, and the first sending unit 1103 can send the second message to the second receiving module 2213. The copying module 2219 can copy the temporary files from the backup storage 240 of the second agent 20 to a logical volume manager (not shown) of the VM 210. The verifying module 2224 can verify the temporary files with the corresponding md5 values stored in the storage 120 of the backup manager 10. After the temporary files are verified, the creating module 2217 can combine the temporary files in a sequence of copying the temporary files to the second agent 20, thereby recovering each LV 221 of the VM 210.

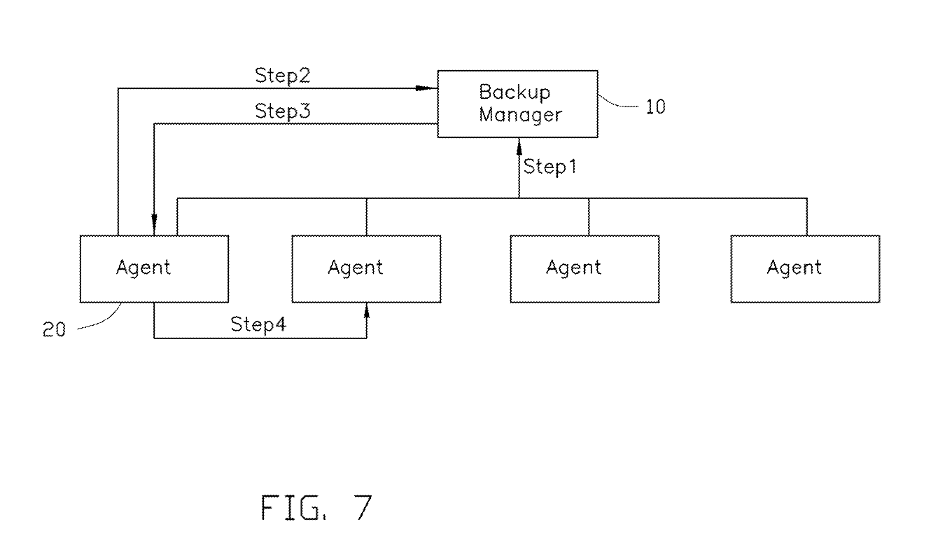

FIG. 7 illustrates a schematic diagram of an example embodiment of a process of the first agent 20 (shown in FIG. 8) backing up the VM 210 to the second agent 20 (shown in FIG. 8). In at least one embodiment, each agent 20 can first report information to the backup manager 10 at a predetermined time interval. The information can include a current amount of free space in the backup storage 240. Next, the first agent 20 can send a backup request to the backup manager 10 when the first agent needs to back up the VM 210 to another agent 20. After the backup manager 10 receives the backup request from the first agent 20, the backup manager 10 can send a message to the first agent 20 that the second agent 20 has the largest current amount of free space of the other agents 20. Finally, after receiving the message, the first agent 20 can back up the VM 210 to the second agent 20.

Referring to FIG. 8, the plurality of LVs 211 of the VM 211 of the first agent 20 can be copied to the backup storage 240 of the second agent 20.

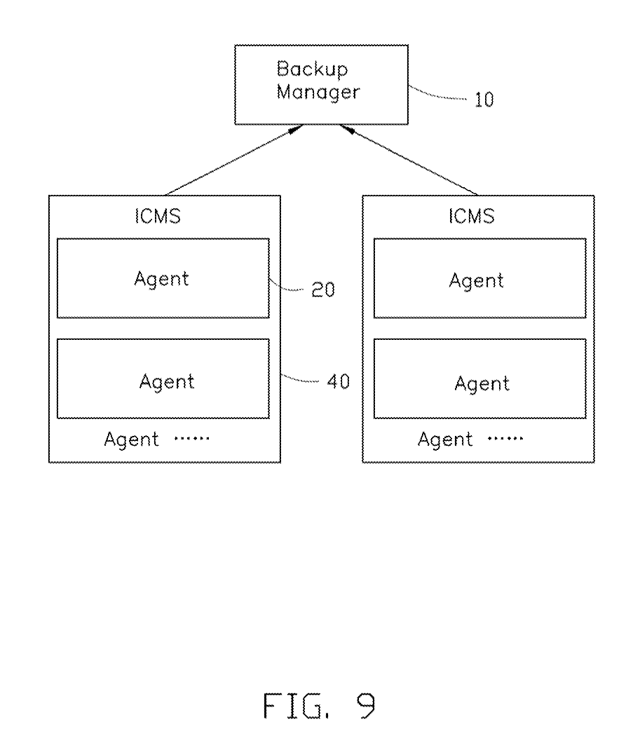

FIG. 9 illustrates a second embodiment of a backup management system. The backup management system of the second embodiment is similar to the backup management system of the first embodiment, except that the plurality of agents 20 can be managed by one or more inter-cloud management systems (ICMS) 40. The plurality of agents 20 can communicate with the backup manager 10 and with each other through the ICMS 40.

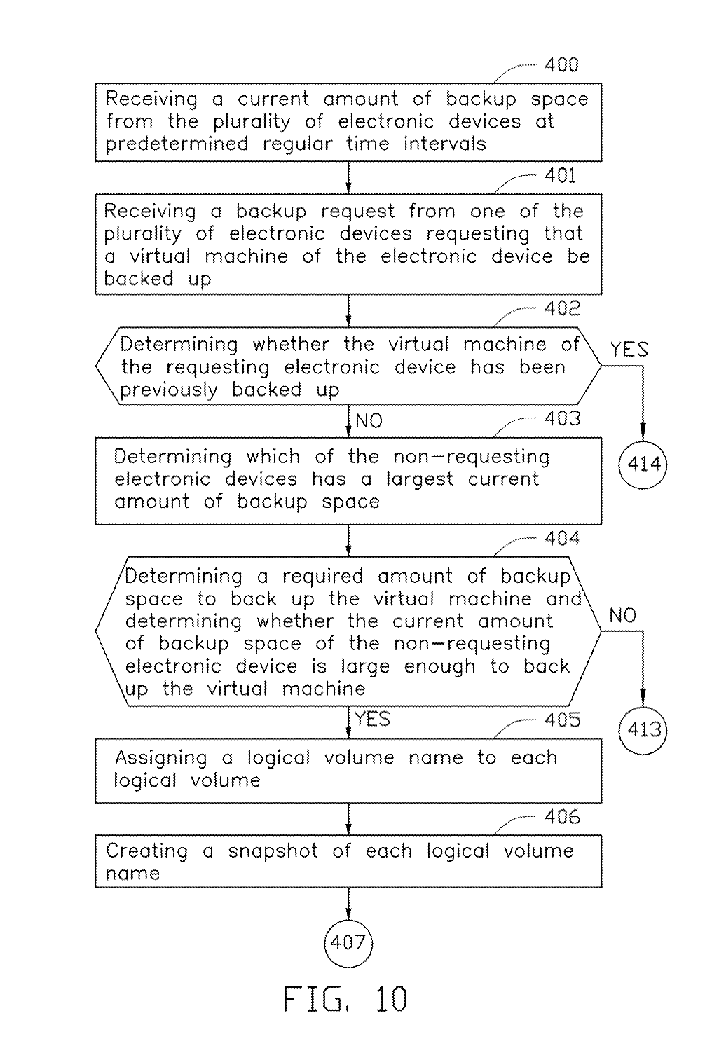

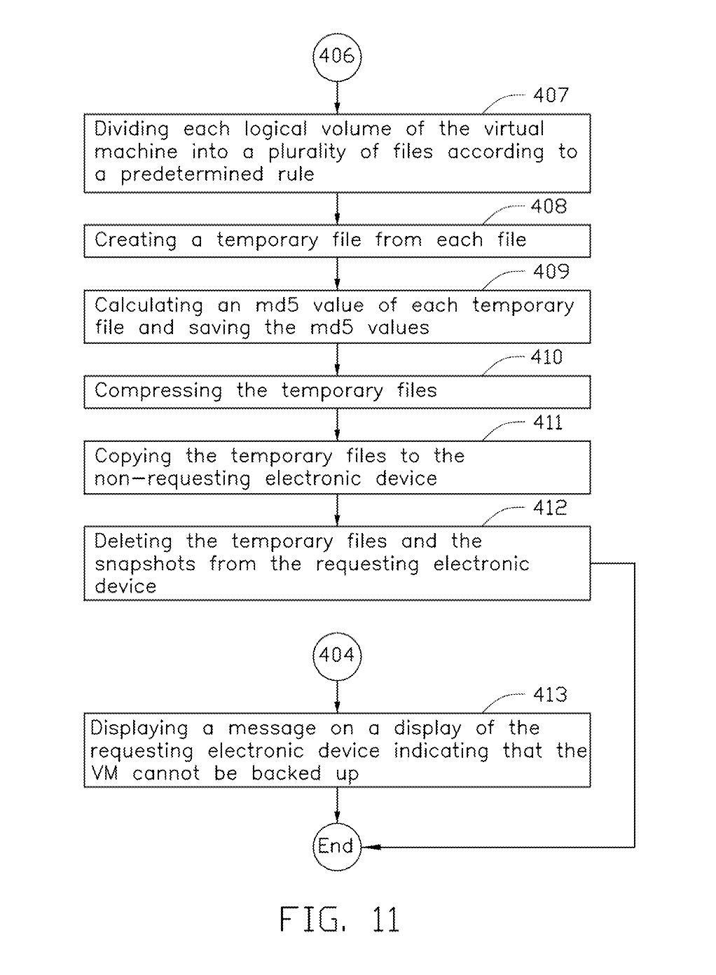

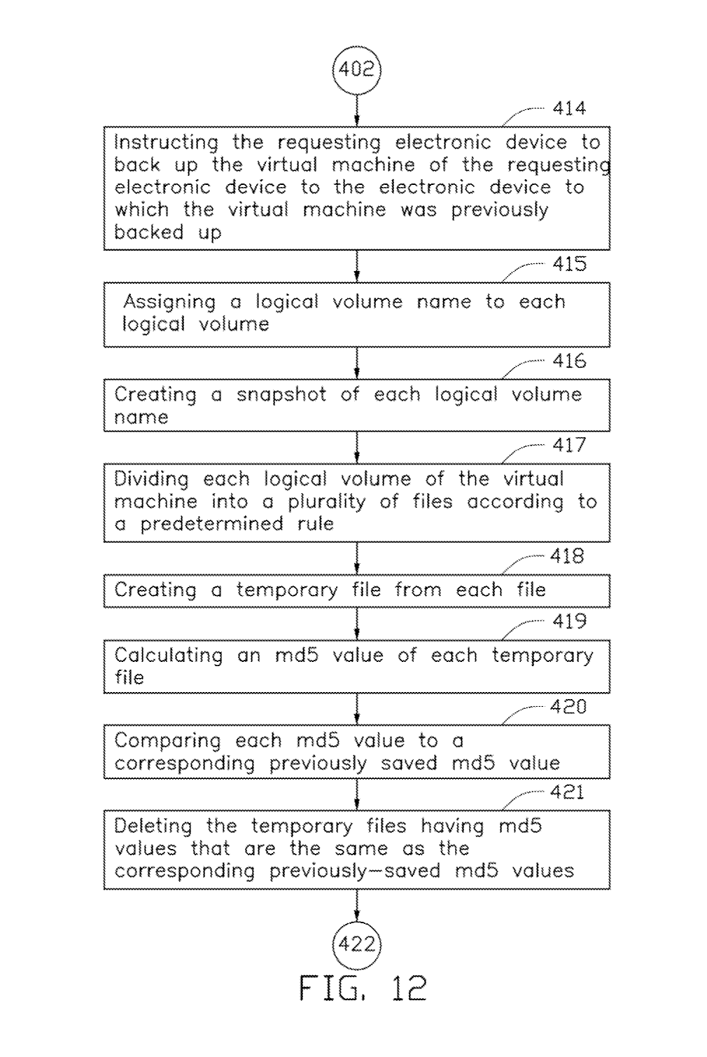

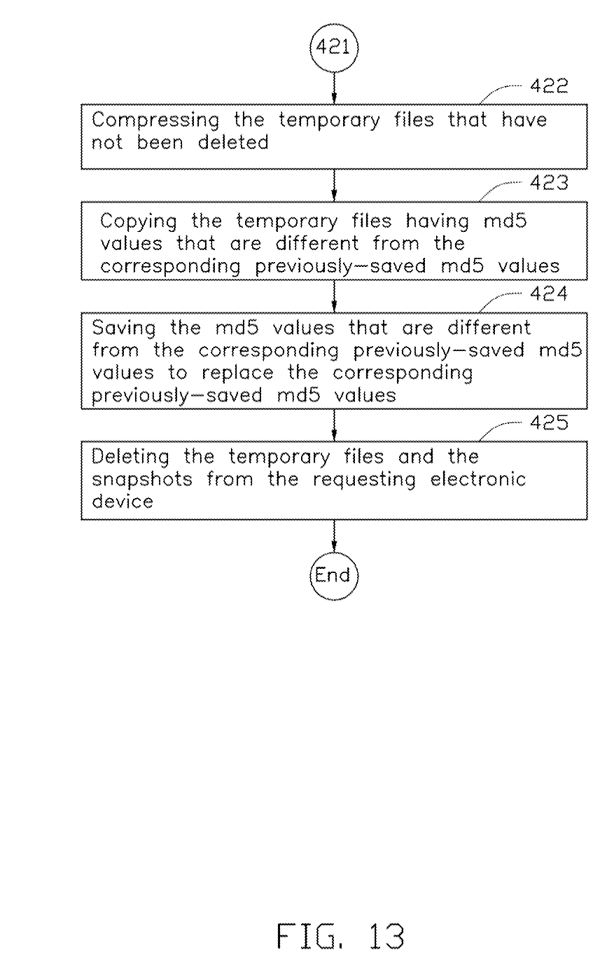

FIGS. 10-13 illustrate a flowchart of an example embodiment of a backup management method 400. The method is provided by way of example, as there are a variety of ways to carry out the method. The method described below can be carried out using the configurations illustrated in FIGS. 1-6, for example, and various elements of these figures are referenced in explaining the method. Each block shown in FIGS. 10-13 represent one or more processes, methods, or subroutines carried out in the method. Additionally, the illustrated order of blocks is by example only, and the order of the blocks can be changed. The backup management method 400 can begin at block 400.

At block 400, information including a current amount of free space of a plurality of electronic devices is obtained at predetermined regular time intervals.

At block 401, a backup request is received from one of the plurality of electronic devices requesting that a virtual machine (VM) of the electronic device be backed up.

At block 402, whether the VM of the requesting electronic device has been previously backed up is determined. If the VM has been previously backed up, block 415 is implemented. If the VM has not been previously backed up, block 403 is implemented.

At block 403, an electronic device of the non-requesting electronic devices having a largest current amount of backup space is determined.

At block 404, a required amount of backup space of the determined non-requesting electronic device to back up the VM and whether the required amount of backup space is large enough to back up the VM are determined. If the current amount of backup space of the non-requesting electronic device is not large enough, block 414 is implemented. If the current amount of backup space is large enough, block 405 is implemented.

At block 405, a logical volume (LV) name is assigned to each of a plurality of LVs of the virtual machine.

At block 406, a snapshot of each LV name is created.

At block 407, each LV of the VM is divided into a plurality of files according to a predetermined rule.

At block 408, a temporary file is created from each file.

At block 409, an md5 value of each temporary file is calculated and saved.

At block 410, the temporary files are compressed.

At block 411, the temporary files are copied to the non-requesting electronic device.

At block 412, the temporary files and the snapshots are deleted from the requesting electronic device, and then the method ends.

At block 413, a message indicating that the VM cannot be backed up is displayed on a display of the requesting electronic device.

At block 414, the requesting electronic device is instructed to back up the VM to the non-requesting electronic device to which the VM was previously backed up.

At block 415, an LV name is assigned to each LV of the VM.

At block 416, a snapshot of each LV name is created.

At block 417, each LV of the VM is divided into a plurality of files according to a predetermined rule.

At block 418, a temporary file is created from each file.

At block 419, an md5 value of each temporary file is calculated.

At block 420, each md5 value is compared to a corresponding previously saved md5 value.

At block 421, the temporary files having md5 values that are the same as the corresponding previously-saved md5 values are deleted.

At block 422, the temporary files that have not been deleted are compressed

At block 423, the temporary files having md5 values that are different from the corresponding previously-saved md5 values are copied to the non-requesting electronic device.

At block 424, the md5 values that are different from the corresponding previously-saved md5 values are saved to replace the corresponding previously-saved md5 values.

At block 425, the temporary files and the snapshots are deleted from the requesting electronic device.

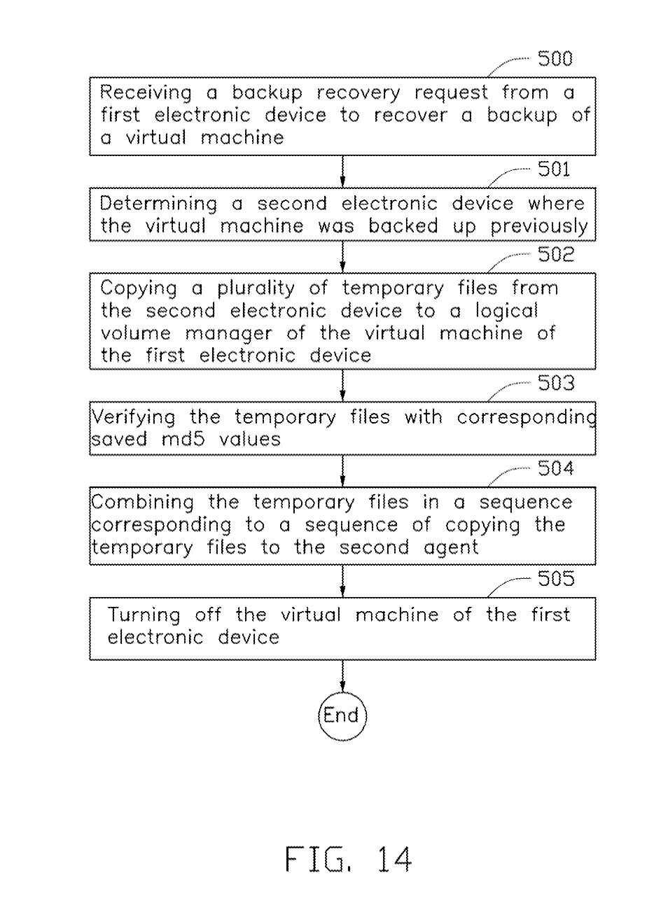

FIG. 14 illustrates a flowchart of an example embodiment of a backup recovery method 500. The method is provided by way of example, as there are a variety of ways to carry out the method. The method described below can be carried out using the configurations illustrated in FIGS. 1-6, for example, and various elements of these figures are referenced in explaining the method. Each block shown in FIG. 14 represents one or more processes, methods, or subroutines carried out in the method. Additionally, the illustrated order of blocks is by example only, and the order of the blocks can be changed. The backup recovery method 500 can begin at block 501.

At block 501, a first electronic device sends a backup recovery request of a virtual machine (VM) to a backup manager.

At block 502, the backup manager determines a second electronic device where the VM was backed up to before.

At block 503, the first electronic device copies temporary files of logical volumes (LVs) of the VM to a logical volume manager of the VM. The first electronic device verifies the temporary files with corresponding md5 values stored in the backup manager.

At block 504, the first electronic device combines the temporary files in a sequence corresponding to a sequence of copying the temporary files to the second electronic device, thereby recovering the LVs of the VM.

At block 505, the first electronic device turns off the VM.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A backup management system comprising:
a backup manager; and
a plurality of agents in communication with the backup manager and with each other through a network;
wherein each of the plurality of agents comprises at least one virtual machine (VM); each of the plurality of agents is capable of sending a backup request to the backup manager when the agent needs to back up the at least one VM thereof; the backup manager is capable of instructing the agent how to back up the at least one VM to another agent of the plurality of agents.

2. The backup management system as described in claim 1, wherein the plurality of agents is managed by one or more inter-cloud management systems, and the plurality of agents can communicate with the backup manager and with each other through the one or more inter-cloud management systems.

3. The backup management system as described in claim 1, wherein the backup manager comprises a backup assistance system (BAS), at least one storage, at least one first processor, and a first communication unit; the backup manager can communicate with the network through the first communication unit; each agent further comprises a backup implementation system (BIS), a backup storage, a second processor, and a second communication unit; each agent can communicate with the network through the second communication unit; the BAS is able to communicate with the BIS of each agent through the network; and the BAS is able to assist each agent in backing up the at least one VM to another agent.

4. The backup management system as described in claim 3, wherein the BAS comprises a first receiving module and a first sending module; the BIS comprises a second sending module and a second receiving module; the second sending module is able to send information to the first receiving module at predetermined time intervals, the information comprising a current amount of free space of the backup storage of the agent; the second sending module is further able to send a backup request of the at least one VM to the first receiving module; the first sending module is able to send a message to the second receiving module, the message instructing the agent how to back up the at least one VM.

5. The backup management system as described in claim 4, wherein the BAS further comprises a determining module able to determine whether the at least one VM of each agent has been backed up before; the first sending module is able to send a first message to the second receiving module when the determining module determines that the at least one VM has not been backed up before, the first message instructing the agent to back up the at least one VM to a specified agent; the first sending module is further able to send a second message to the second receiving module when the determining module determines that the at least one VM has been backed up before, the second message informing the agent that the at least one VM was backed up to a previous specified agent before, the previous specified agent being the specified agent when the at least one VM was backed up before.

6. The backup management system as described in claim 5, wherein the determining module is further able to determine which agent of a group of agents has a greatest current amount of free space, the group of agents consisting of all of the plurality of agents except for the agent that sent the backup request, and the agent of the group of agents having the largest current amount of free space being the specified agent.

7. The backup management system as described in claim 5, wherein the BIS further comprises a dividing module, a calculating module, a creating module, a saving module, and a copying module; the at least one VM of each agent comprises a plurality of logical volumes (LVs); the dividing module is able to divide each LV into a plurality of files according to a predetermined rule; the creating module is able to create a temporary file from each file; the calculating module is able to calculate an md5 value of each temporary file; the saving module is able to save each md5 value to the at least one storage of the backup manager; and the copying module is able to copy each temporary file to the backup storage of the specified agent.

8. The backup management system as described in claim 7, wherein the BIS further comprises a compressing module, a naming module, a deleting module, and a comparing module; the calculating module is further able to calculate a required amount of backup space for backing up the at least one VM to the specified agent; the compressing module is able to compress the plurality of temporary files before the temporary files are copied to the specified agent; the naming module is able to assign an LV name to each LV before the LV is divided into a plurality of files; the creating module is further able to create a snapshot of each LV name; the comparing module is able to compare the md5 value of each temporary file of the backup agent to a corresponding md5 value stored in the at least one storage of the backup manager when the at least one VM has been backed up before; the deleting module is able to delete the temporary files from the corresponding agent after the temporary files have been copied to the backup storage of the specified agent.

9. The backup management system as described in claim 7, wherein the BIS further comprises a verifying module; when the corresponding agent needs to recover the backup of the at least one VM from the specified agent, the verifying module is able to verify the temporary files backed up to the specified agent with the corresponding md5 values stored in the at least one storage of the backup manager.

10. An electronic device backup management method comprising:
receiving at predetermined regular time intervals from a plurality of electronic devices, a current amount of backup space for each of the plurality of electronic devices;
receiving a backup request from one of the plurality of electronic devices requesting that a virtual machine of the electronic device be backed up;
determining whether the virtual machine of the requesting electronic device has been previously backed up;
determining which of the non-requesting electronic devices has a largest current amount of backup space, if the virtual machine of the requesting electronic device has not been previously backed up;
instructing the requesting electronic device to back up the virtual machine of the requesting electronic device to the non-requesting electronic device with the largest current amount of backup space upon determining that the virtual machine of the requesting device has not been previously backed up; and
instructing the requesting electronic device to back up the virtual machine of the requesting electronic device to the electronic device to which the virtual machine was previously backed up, upon determining that the virtual machine of the requesting electronic device has been previously backed up to one of the plurality of electronic devices.

11. The electronic device backup management method as described in claim 10 further comprising;
upon determining that the virtual machine has not been previously backed up, determining a required amount of backup space to back up the virtual machine of the requesting electronic device;
backing up the virtual machine to the non-requesting electronic device with the largest current amount of free space, upon determining that the current amount of free space of the non-requesting electronic device is large enough to back up the virtual machine; and
instructing the requesting electronic device to display a message indicating that the current amount of free space of the non-requesting electronic device is not large enough to back up the virtual machine of the requesting electronic device, upon determining that the current amount of free space of the non-requesting electronic device is not large enough to back up the virtual machine of the requesting electronic device.

12. The electronic device backup management method as described in claim 11, wherein the required amount of backup space is determined by acquiring a total size of logical volumes of the virtual machine, and multiplying the total size of the logical volumes by a compression ratio.

13. The electronic device backup management method as described in claim 12 further comprising;
dividing each logical volume of the virtual machine into a plurality of files according to a predetermined rule, upon determining that the current amount of backup space of the non-requesting electronic device with the largest current amount of backup space is large enough to back up the virtual machine of the electronic device;
creating a temporary file from each file;
calculating an md5 value of each temporary file and saving the md5 values; and
copying the temporary files to the non-requesting electronic device with the largest current amount of backup space.

14. The electronic device backup management method as described in claim 13 further comprising;
assigning a logical volume name to each logical volume before each logical volume is divided into the plurality of files;
creating a snapshot of each logical volume name;
compressing the temporary files before the temporary files are copied to the non-requesting electronic device with the largest current amount of backup space; and
deleting the temporary files and the snapshots from the requesting electronic device after the temporary files have been copied.

15. The electronic device backup management method as described in claim 10 further comprising;
upon determining that the virtual machine has been previously backed up, dividing each logical volume of a plurality of logical volumes of the virtual machine into a plurality of files according to a predetermined rule;
creating a temporary file from each file;
calculating an md5 value of each temporary file;
comparing each md5 value to a corresponding previously saved md5 value;
deleting the temporary files having md5 values that are the same as the corresponding previously-saved md5 values;
copying the temporary files having md5 values that are different from the corresponding previously-saved md5 values to the electronic device where the virtual machine was previously backed up to replace the corresponding previously copied temporary files; and
saving the md5 values that are different from the corresponding previously-saved md5 values to replace the corresponding previously-saved md5 values.

16. The electronic device backup management method as described in claim 15 further comprising;
assigning a logical volume name to each logical volume before each logical volume is divided into the plurality of files;
assigning a logical volume name to each logical volume;
creating a snapshot of each logical volume name;
compressing the temporary files before the temporary files are copied to the electronic device where the virtual machine was previously backed up; and
deleting the temporary files and the snapshots from the requesting electronic device after the temporary files have been copied.

17. A backup recovery method comprising:
receiving a backup recovery request from a first electronic device to recover a backup of a virtual machine of the electronic device;
determining a second electronic device where the virtual machine was backed up previously;
copying a plurality of temporary files from the second electronic device to a logical volume manager of the virtual machine of the first electronic device, the temporary files having been created from corresponding files of a plurality of logical volumes of the virtual machine;
verifying the temporary files with corresponding saved md5 values;
combining the temporary files in a sequence corresponding to a sequence of copying the temporary files to the second agent; and
turning off the virtual machine of the first electronic device.
